(19) United States
(12) Patent Application Publication
(10) Pub. No.: US 2003/0020767 A1
(43) Pub. Date: Jan. 30, 2003

(54) Grain forming ink jet printer for printing a grain on a workpiece and method of assembling the printer

(76) Inventor: Thomas A. Saksa, Albany, OR (US)

Correspondence Address: HEWLETT-PACKARD COMPANY, Intellectual Property Administration, P.O. Box 272400, Fort Collins, CO, 80527-2400, US

(21) Appl. No.: 09/912,742

(22) Filed: Jul. 24, 2001

(51) Int. Cl. B41J 3/00

(52) U.S. Cl. 347/2; 347/108

(57) ABSTRACT

A grain forming ink jet printer for printing a grain on a workpiece and method of assembling the printer. The printer comprises an ink jet print head adapted to apply ink onto the workpiece for printing the grain on the workpiece. A spacer member is associated with the print head for maintaining a predetermined space between the print head and the workpiece. A support member is spaced-apart from the print head for supporting the workpiece and a biasing mechanism is coupled to the support member for biasing the support member, so that the support member moves the workpiece into engagement with the spacer member. A data storage unit is coupled to the print head for storing image data defining the grain and for transferring the image data to the print head. The data storage unit is also adapted to generate the image data. Alternatively, rather than the data storage unit itself generating the image data, a scanner may be coupled to the data storage unit for scanning a master or sample grain, for generating the image data from the scanned sample grain and for transferring the image data to the data storage unit. A dryer unit is also provided for drying the ink applied to the workpiece. Moreover, a finisher unit is provided for applying a finish to the printed workpiece in order to protect the applied grain from damage.

### BACKGROUND OF THE INVENTION

The present invention generally relates to printer apparatus and methods and more particularly relates to a grain forming ink jet printer for printing a grain on a workpiece and method of assembling the printer.

For aesthetic reasons, consumers many times prefer that products, such as furniture, doors, automobile dashboards and kitchen countertops, have a wood, leather or a marble grain appearance. In the opinion of many consumers, such a wood, leather or marble grain appearance connotes quality of construction and durability.

However, products constructed from naturally-occurring wood, leather or marble may lack a specific a color and/or hue desired by a prospective purchaser of the product. In addition, naturally-occurring wood, leather or marble may lack a specific grain pattern desired by the prospective purchaser of the product. Further, products constructed from naturally-occurring wood, leather or marble may be expensive to make due to cost of materials and machining.

Therefore, it is desirable to provide synthetic wood, leather or marble products having simulated wood, leather or marble grain for achieving an aesthetically pleasing appearance for the product while reducing cost of materials and machining. For example, it may be desirable to fabricate a door made of inexpensive crushed cellulose, rather than a solid wood door, and then imprint a mahogany wood grain on the door to provide a door having an expensive “mahogany wood look” but at reduced cost. As another example, it may be desirable to fabricate an automobile dashboard covered by inexpensive plastic sheeting, rather than leather, and then imprint a leather grain on the plastic sheeting to provide a dashboard having an expensive “leather look” but at reduced cost.

Techniques for imprinting wood, leather or marble grain on synthetic and simi-finished products are known. A technique for printing wood grain on a substrate is disclosed by U.S. Pat. No. 5,989,681 titled “Semi-Finished Wood Simulating Product” issued Nov. 23, 1999 in the name of Ralph A. Martino. The Martino patent discloses a semi-finished product capable of accepting wood stain, paint or varnish as applied by an end user at an installation site and also discloses methods of manufacturing semi-finished wood simulating products. According to the Martino disclosure, the method of manufacturing the semi-finished wood simulating product includes a conveyor portion that transports the substrate to a rotogravure print station. A wood grain pattern, such as mahogany, teak, or oak, is applied using a conventional rotogravure technique at the print station. The wood grain pattern is printed with an acrylic print ink. Moreover, according to the Martino disclosure, the substrate is sequenced for entry into the print station so that no two print patterns are exactly the same. However, the Martino patent does not disclose a technique to instantaneously vary the print pattern. In other words, the Martino technique appears to require time-consuming adjustment of the sequence for entry of the substrate into the print station so that no two print patterns are exactly the same. In addition, use of the Martino technique is relatively expensive because the Martino technique uses the rotogravure printing process, which requires fabrication of an intaglio plate prepared by photographic methods. Of course, an intaglio plate is an engraving cut deeply into a surface of a hard material, which is typically metal. Moreover, the Martino patent does not disclose a technique to instantaneously accommodate substrates of differing thicknesses. Further, the Martino patent does not disclose printing edge surfaces of the substrate. Printing edge surfaces of a simulated wood product, as well as the main or non-edge surfaces, increases aesthetic appeal.

A technique for forming a wood grain pattern on a synthetic wood board made of cellulose crushed material and thermoplastic resin material is disclosed by U.S. Pat. No. 5,869,138 titled “Method For Forming Pattern On A Synthetic Wood Board” issued Feb. 9, 1999 in the name of Sadao Nishibori. The Nishibori patent discloses that as a first step, cellulose crushed material and thermoplastic resin are mixed at an appropriate mixing ratio so that a woody like appearance of a wood board can be obtained before applying a wood grain pattern. This results in a synthetic wood board made of cellulose crushed material and PVC (polyvinyl chloride). A surface of the synthetic wood board is then ground by sand paper, so that a large number of “wound stripes” are formed on the entire surface of the wood board. Using this technique, the heights of recesses and projections of the wound stripes are large and depth, width, and length of the wound stripes are varied. Water-soluable colorant such as lacquer is coated on the entire sanded surface of the wood board by a roll or spray. The wood board is then dried naturally. The colorant permeates within the recess of the wound stripes and forms a recess pigment layer. The colorant also permeates into the exposed surface of the wood board. Next, the wood board is subjected to grinding again, except for the recessed pigment layer. The sand paper used for the second grinding process is rougher that the sand paper used in the first grinding process and partially removes some of the colored surface of the wood board. According to the Nishibori patent, this process will produce a blurred shading effect to the wood grain to be applied by varying the refractive index of the surface of the wood board. Next, a wood grain pattern is printed by role print or flexographic printing on the surface of the wood board and a finish coating is applied. The wood grain may be of monochrome or polychrome, and may include various patterns of grain of natural wood. According to the Nishibori disclosure, a wood grain pattern appears which is close to the grain of natural wood. However, the Nishibori patent does not disclose a technique to instantaneously vary the print pattern. In addition, use of the Nishibori technique is relatively capital-intensive and therefore costly because the Nishibori technique requires apparatus for mixing cellulose crushed material and thermoplastic resin at an appropriate mixing ratio so that a woody like appearance of the wood board can be obtained before applying the printed wood grain pattern. Moreover, the Nishibori patent does not disclose a technique to instantaneously accommodate wood boards of differing thicknesses. Further, although the Nishibori patent discloses coating the entire surface of the wood board with colorant, the Nishibori patent does not expressly disclose structure that accomplishes this result.

Hence, a problem in the art is to provide an ink jet printer that instantaneously varies the grain pattern.

Another problem in the art is to provide an ink jet printer that is inexpensive to assemble.

A further problem in the art is to provide an ink jet printer that instantaneously accommodates workpieces of differing thicknesses.

Still another problem in the art is to provide an ink jet printer that prints edge surfaces of the workpiece.

Therefore, what is needed is a grain forming ink jet printer for printing a grain on a workpiece and method of assembling the printer, such that the printer instantaneously varies the grain pattern, is inexpensive to assemble, instantaneously accommodates workpieces of differing thicknesses and that prints edge surfaces of the workpiece.

### SUMMARY OF THE INVENTION

According to an aspect of the present invention, a grain forming ink jet printer for printing a grain on a workpiece comprises an ink jet print head adapted to apply ink or stain onto the workpiece for printing the grain on the workpiece. The printer includes a spacer member that is associated with the print head for maintaining a predetermined space between the print head and the workpiece. A support member is spaced-apart from the print head for supporting the workpiece to a position adjacent the print head. A biasing mechanism is coupled to the support member for biasing the support member, so that the support member moves the workpiece into engagement with the spacer member. In this manner, the spacer member maintains the predetermined space between the workpiece and the print head. A data storage unit is coupled to the print head for storing image data defining the grain pattern. The data storage unit also transfers the image data to the print head. The data storage unit is also adapted to generate the image data by means of a suitable commercially available algorithm. Alternatively, a scanner may be coupled to the data storage unit for scanning a master or sample grain pattern, for generating the image data from the scanned sample grain pattern and for transferring the image data to the data storage unit. The data storage unit then transfers the image data, obtained by scanning the sample grain pattern, to the print head. A dryer unit is also provided for drying the ink applied to the workpiece. Moreover, a finisher unit is provided for applying a finish to the workpiece in order to protect the applied grain from damage.

A feature of the present invention is the provision of a spacer member connected to the print head and a support member disposed opposite the print head for capturing the workpiece therebetween, so that workpieces of varying thicknesses can be positioned at a predetermined distance from the print head.

Another feature of the present invention is the provision of a data storage unit for generating image data representing a desired grain and for transferring the image data to the print head to print the grain onto the workpiece.

A further feature of the present invention is the provision of a scanner for scanning a master or sample grain, converting the scanned image into image data and transferring the image data to the data storage unit, so that image data unit transfers the image data to the print head.

An advantage of the present invention is that use thereof provides a grain forming ink jet printer that instantaneously varies the grain pattern.

Another advantage of the present invention is that use thereof provides a grain forming ink jet printer that is inexpensive to assemble because use of capital-intensive printing technology, such as the rotogravure printing technique, is avoided.

A further advantage of the present invention is that use thereof provides a grain forming ink jet printer that instantaneously accommodates workpieces of differing thicknesses.

Still another advantage of the present invention is that use thereof provides a grain forming ink jet printer that prints edge surfaces of the workpiece while non-edge surfaces are being printed.

These and other features and advantages of the present invention will become apparent to those skilled in the art upon a reading of the following detailed description when taken in conjunction with the drawings wherein there are shown and described illustrative embodiments of the invention.

### BRIEF DESCRIPTION OF THE DRAWINGS

While the specification concludes with claims particularly pointing-out and distinctly claiming the subject matter of the present invention, it is believed the invention will be better understood from the following description when taken in conjunction with the accompanying drawings wherein:

FIG. 1 is a view in partial elevation of a first embodiment grain forming ink jet printer ejecting an ink drop for printing a grain on a workpiece;

FIG. 2 is a view of the first embodiment printer in partial elevation taken along section line 2-2 of FIG. 1;

FIG. 3 is a plan view of the first embodiment printer printing the grain on the workpiece;

FIG. 4 is a fragmentation plan view of the workpiece showing the grain after being printed, this view also showing a first print swath having a first width and a second print swath having a second width wider than the first width;

FIG. 5 is a view in partial elevation of a second embodiment grain forming ink jet printer ejecting a plurality of ink drops for printing the grain on the workpiece; and

FIG. 6 is a view of the second embodiment printer in partial elevation taken along section line 6-6 of FIG. 5.

### DETAILED DESCRIPTION OF THE PREFERRED EMBODIMENT(S)

The present invention will be directed in particular to elements forming part of, or cooperating more directly with, apparatus in accordance with the present invention. It is to be understood that elements not specifically shown or described may take various forms well known to those skilled in the art.

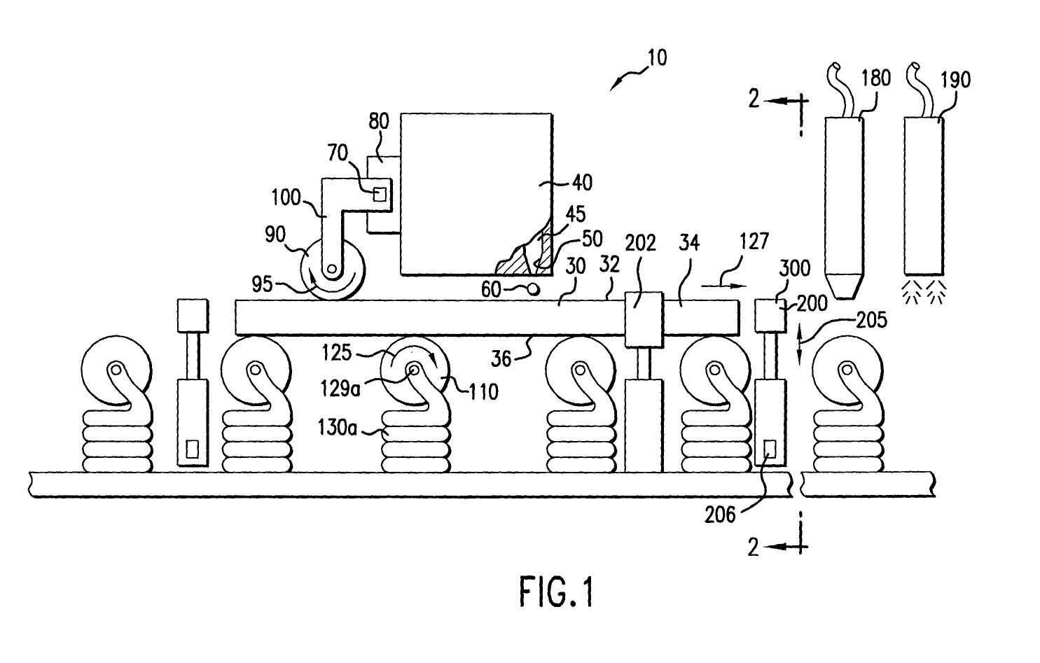

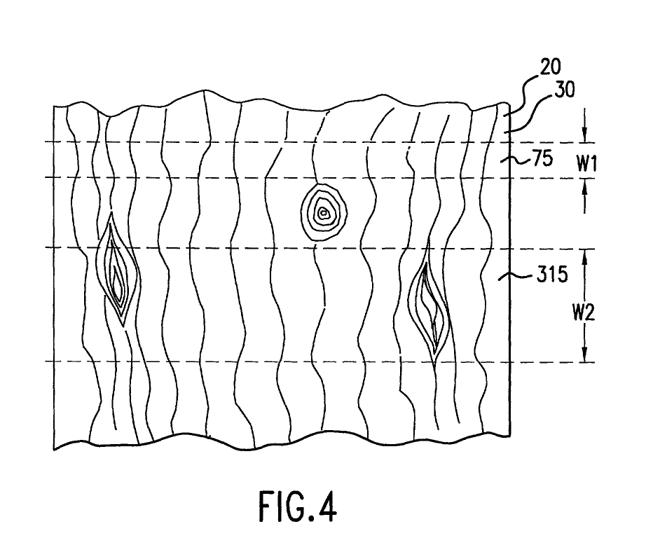

Therefore, referring to FIGS. 1, 2 and 3, there is shown a first embodiment grain forming ink jet printer, generally referred to as 10, for printing a grain 20 on a workpiece 30. Workpiece 30 has a top surface 32, a plurality of edge surfaces 34, and a bottom surface 36. Grain 20 simulates any of a number of naturally-occurring grain patterns, such as wood grain patterns found in oak, teak, and maple, or the like. Grain 20 may also simulate grain pattern found in leather. Alternatively, grain 20 may simulate grain pattern present in various stone marbles. By way of illustration only, and not by way of limitation, grain 20 is shown as a wood grain (see FIG. 4). Workpiece 30 itself may be any suitable workpiece upon which grain 20 is to be formed, such as articles of furniture, doors, automobile dashboards or kitchen countertops. The articles themselves may have a composition made of wood, leather, plastic, paper, metal or other desired composition.

Referring again to FIGS. 1, 2 and 3, printer 10 comprises an ink jet print head 40 having formed therein a row defined by a plurality of collinearly-aligned ink ejection chambers 45, each chamber 45 terminating in an orifice 50 for ejecting an ink drop 60 onto top surface 32. The ink may be used to stain a wood workpiece 30. Thus, orifices 50 are collinearly-aligned because chambers 45 are collinearly-aligned. Each orifice 50 may respectively eject a specific ink color, such as magenta, yellow, cyan and optionally black. A plurality of ink drops 60 form grain 20 on workpiece 30 according to a predetermined pattern, as described in more detail hereinbelow. In addition, print head 40 is preferably of a type such as disclosed in U.S. Pat. No. 6,231,168 titled “Ink Jet Print Head With Flow Control Manifold Shape” issued May 15, 2001 in the name of Robert C. Maze and assigned to the assignee of the present invention, the disclosure of which is hereby incorporated by reference.

Referring to FIGS. 1, 2, 3 and 4, print head 40 is slidably mounted on a rail 70 extending at least the width of workpiece 30, so that print head 40 prints grain 20 in a first printing swath 75 having a first width “W1”. Print head 40 reciprocatingly traverses rail 70 in direction of double-headed arrow 77 by means of a motor mechanism 80 connected to print head 40 and engaging rail 70. A spacer member, which may be a freely-rotatable roller 90, is connected to print head 40, such as by means of a bracket 100. Roller 90 is freely-rotatable in direction of curved arrow 95. Roller 90 engages top surface 32 of workpiece 30 for maintaining a predetermined space between orifices 50 of print head 40 and top surface 32 and preferably extends at least the width of workpiece 30. It is important to maintain a predetermined space between orifices 50 and top surface 32. This is important in order to allow ink drops 60 to achieve substantially spherical shape and predetermined velocity after ejection from orifices 50, so that ink drops 60 suitably intercept top surface 30 to achieve a desired ink dot resolution thereon.

Returning to FIGS. 1, 2 and 3, a support member, such as a platen 110, is spaced-apart from and disposed opposite to print head 40 for supporting workpiece 30. Platen 110 may be configured as an elongate or cylindrical roller operable by a motor 120 for rotating platen 110 in direction illustrated by curved arrow 125, so that workpiece 30 moves in direction of arrow 127. In this regard, there are preferably a plurality of platens 110 aligned so as to move workpiece 30 suitably past orifices 50. Each of platens 110 has opposing end mounts 129a and 129b connected to respective ends thereof for reasons disclosed hereinbelow.

It will be understood from the description hereinabove, that print head 40 is caused to traverse rail 50 in a first printing direction to print a first one of the first printing swaths 75. As first printing swath 75 is printed, platens 110 are not rotated so that platens 110 remain stationary. Then, platens 110 are rotated through a predetermined angle to advance workpiece 30 a predetermined distance in direction of arrow 127. At that point, print head 40 is caused to traverse rail 50 in a second printing direction opposite the first printing direction to print a second one of the first printing swaths 75. In other words, print head 40 reciprocatingly traverses rail 70 in direction of arrow 77. Platens 110 are rotated only after print head 40 reaches an end portion of rail 70 during the reciprocating motion of print head 40. This process moving print head 40 and rotating platens 110 is repeated until a desired portion of top surface 32 receives grain 20. Of course, platens 110 are controllably rotated such that the plurality of first printing swaths 75 present a seamless grain 20 on top surface 32.

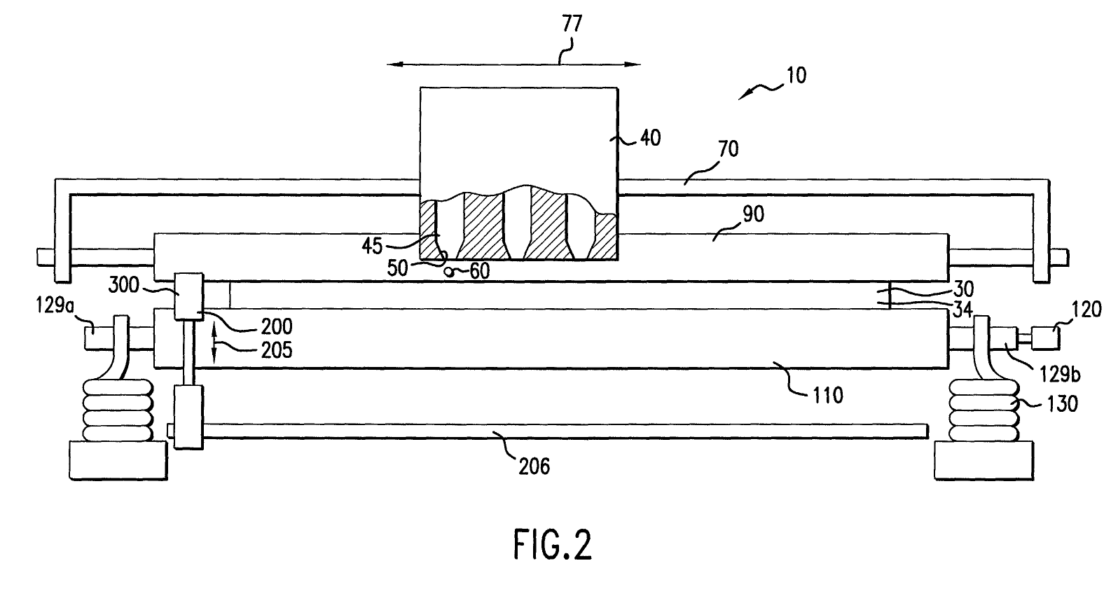

As best seen in FIGS. 1 and 2, a biasing mechanism, such as coiled springs 130a and 130b, is connected to each of end mounts 129a and 129b and may rest on foundations 135a and 135b for support. In other words, foundations 135a and 135b support springs 130a and 130b, respectively. The purpose of springs 130a/b is to vertically bias platen 110, so that platen 110 vertically translates workpiece 30 into engagement with roller 90. In this manner, roller 90 and springs 130a/b coact to maintain the predetermined distance between orifices 50 and top surface 32 for printing grain 20 of acceptable dot resolution.

Referring to FIGS. 1, 2, and 3, printer 10 further comprises a data storage unit, such as a computer 140, coupled to print head 40 for storing image data defining grain 20. Computer 140 is also capable of transferring the image data to print head 40 in order to operate print head 40, so that ink drops 60 eject from orifices 50 in a predetermined sequence according to the image data transferred to print head 40. In this regard, computer 140 may be selected from any one of a number of commercially available computers, such as a “BRIO BA410” computer available from the Hewlett-Packard Company located in Palo Alto, Calif. The mark “BRIO BA410” is a trademark of the Hewlett-Packard Company. Moreover, computer 140 is electrically connected to print head 40 by a first cable 150 and is also connected to motors 120 and motor mechanism 80 by additional cables (not shown) for controlling operation of print head 40, motors 120 and motor mechanism 80. In addition, computer 140 may include a software computer program housed therein. The computer program includes an algorithm for generating the image data. In this regard, the computer program may be any suitable computer program, such as the “XENOFEX” computer program available from Alien Skin Software Company located in Raleigh, N.C. The mark “XENOFEX” is a trademark of Alien Skin Software Company.

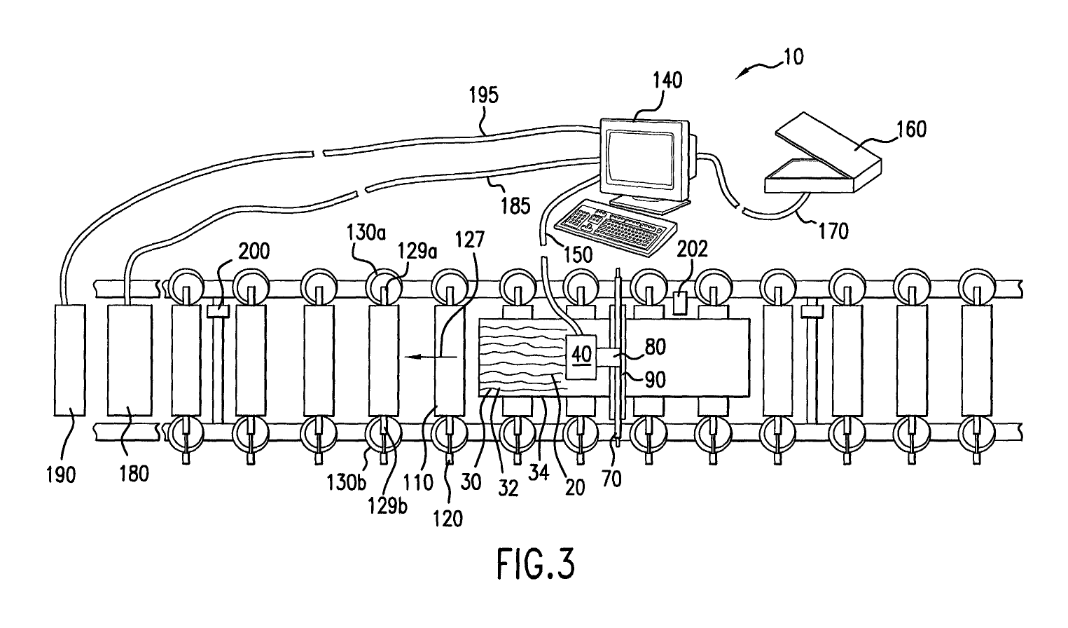

As best seen in FIG. 3, a scanner 170 may be electrically connected to computer 140, such as by a second cable 170 for scanning a master or sample grain (not shown), for generating the image data from the scanned sample grain and thereafter for transferring the image data to computer 140. Of course, there is no need to provide the previously mentioned computer program to generate image data when scanner 160 is used for scanning the sample grain to provide the image data. In this regard, scanner 160 may be an “HP SCANJET 537OCXI” available from the Hewlett-Packard Company located in Palo Alto, Calif. The mark “HP SCANJET 537OCXI” is a trademark of the Hewlett-Packard Company.

Referring to FIGS. 1 and 3, a dryer, such as an electric resistive heater and hot air blower combination 180, is disposed proximate print head 40 for directing a stream of heated air onto the ink deposited on workpiece 30 in order to dry the ink on workpiece 30. Heater and hot air blower combination 180 is electrically connected to computer 140, such as by means of a third cable 185, so that computer 140 controls operation of heater and hot air blower combination 180. In addition, a finisher unit 190 is disposed proximate print head 40 for applying sealant onto workpiece 30 in order to seal the ink deposited onto workpiece 30. Finisher unit 190 is electrically connected to computer 140, such as by a fourth cable 195, for controlling operation of finisher unit 190. Sealing the ink in this manner seals grain 20 and protects grain 20 from damage.

Referring to FIGS. 1, 2 and 3, printer 10 further comprises a plurality of first and second ink jet edger assemblies 200 and 202, respectively, preferably disposed near print head 40 for forming grain 20 on edge surfaces 34 that surround the periphery of workpiece 30. First edger assemblies 200 are capable of vertically telescoping in the direction of double-headed arrow 205, so that edger assemblies 200 do not obstruct or otherwise interfere with workpiece 30 as workpiece travels in direction of arrow 127. Moreover, first edger assemblies 200 ride on an elongate bar 206 extending at least the width of workpiece 30. Second edger assemblies 202 are disposed near lateral ones of edge surfaces 34 of workpiece 30. In this manner, grain 20 is printed on the lateral ones of edge surfaces 34 as workpiece 30 is moved in direction of arrow 127 by rotation of platens 110. Edger assemblies 200 and 202 themselves preferably each comprise an edging ink ejection device 300 capable of ejecting ink drops onto all edge surfaces 34. First and second ink edger assemblies 200 and 202 are electrically connected to computer 140 by means of cables (not shown) for controlling operation of first and second edger assemblies 200 and 202.

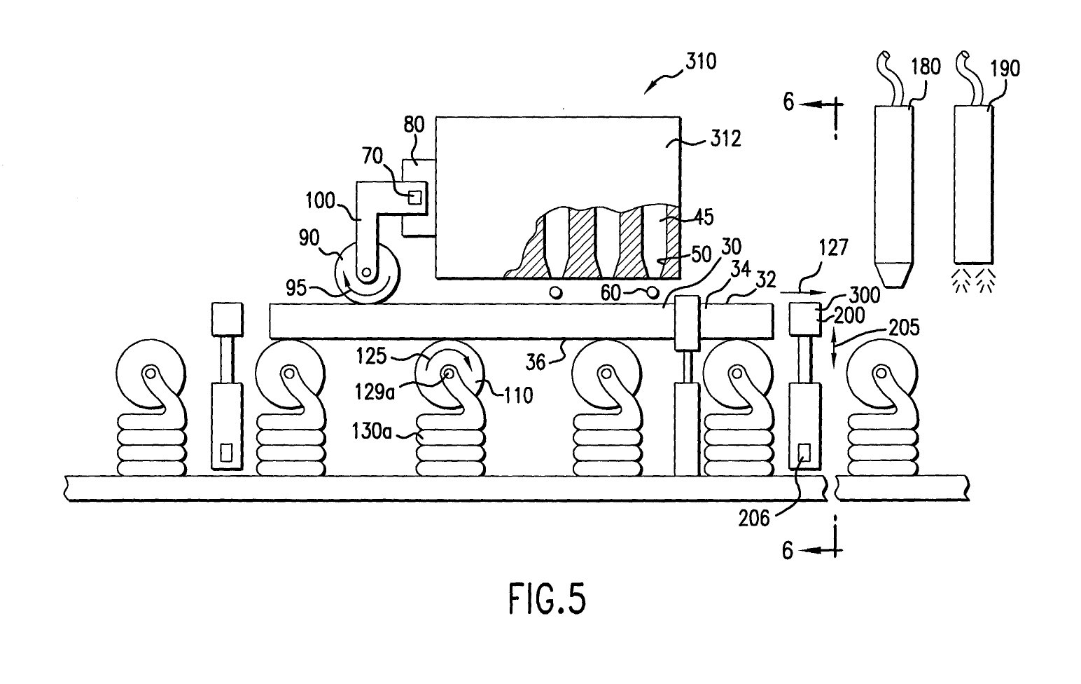

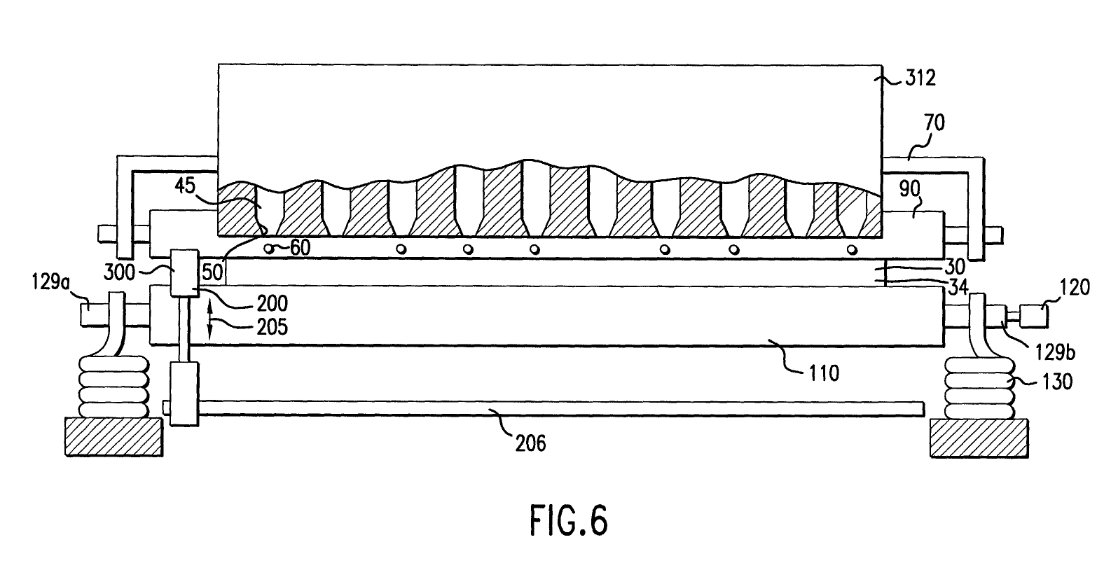

Turning now to FIGS. 5 and 6, there is shown a second embodiment grain forming ink jet printer, generally referred to as 310, for printing grain 20 on workpiece 30. Second embodiment printer 310 is similar to first embodiment printer 10, except that second embodiment printer 310 includes a stationary and elongate second embodiment print head 312. Print head 312 has formed therein a plurality of rows of ink ejection chambers 45. The plurality of rows of ink ejection chambers 45 are collinearly-aligned from row to row for printing a second print swath 315 having a second width “W2” wider than first width “W1” (see FIG. 4). Second embodiment printer 310 is capable of printing grain 20 of top surface 32 of workpiece 30 in less time compared to first embodiment printer 10. This is so because second embodiment print head 312 prints in a wider print swath 315 compared to first embodiment print head 40.

It will be understood from the description hereinabove that an advantage of the present invention is that use thereof provides a grain forming ink jet printer that can instantaneously vary the grain pattern. This is so because computer 140 can instantaneously vary the image data representing grain 20 by use of a suitable computer software program or by scanning a different master or sample grain.

Another advantage of the present invention is that use thereof provides a grain forming ink jet printer that is inexpensive to assemble because use of capital-intensive printing technology, such as the rotogravure printing technique, is avoided. This is so because electronic digitally created image data representing grain 20 is transferred to first embodiment print head 40 or second embodiment print head 312.

A further advantage of the present invention is that use thereof provides a grain forming ink jet printer that instantaneously accommodates workpieces of differing thicknesses. This is so because springs 130a/b elastically move upwardly and downwardly to capture workpiece 30 between roller 90 and platens 110, regardless of thickness of workpiece 30. Capturing workpiece 30 between roller 90 and platens 110 in this manner also maintains the predetermined distance between orifices 50 and workpiece 30, so as to obtain acceptable ink dot resolution on workpiece 30.

Still another advantage of the present invention is that use thereof provides a grain forming ink jet printer that prints edge surfaces 34 of the workpiece 30 while the “non-edge” top surface 32 is being printed. After top surface 32 and edge surfaces 34 are printed, workpiece 30 may be rotated or “flipped over” by any suitable means known in the art to print bottom surface 36 using first embodiment print head 40 or second embodiment print head 312.

While the invention has been described with particular reference to its preferred embodiments, it will be understood by those skilled in the art that various changes may be made and equivalents may be substituted for elements of the preferred embodiments without departing from the invention. For example, a conveyer belt transport system may be substituted for platens 110. As another example, print head 40 may be constructed to print the width and length of workpiece 30 in a raster-like fashion, so that workpiece 30 remains stationary and print head 40 moves during printing.

Therefore, what is provided is a grain forming ink jet printer for printing a grain on a workpiece and method of assembling the printer, which printer is capable of instantaneously varying the grain pattern, is inexpensive to assemble, instantaneously accomodates workpieces of differing thicknesses, and prints edge surfaces of the workpiece.

PARTS LIST

W1 . . . width of first print swath

W2 . . . width of second print swath

10 . . . first embodiment grain forming ink jet printer

20 . . . grain

30 . . . workpiece

32 . . . top surface (of workpiece)

34 . . . side edge surface (of workpiece)

36 . . . bottom surface (of workpiece)

40 . . . ink jet print head

45 . . . ink ejection chamber

50 . . . orifice

60 . . . ink drop

70 . . . rail

75 . . . first print swath

77 . . . arrow

80 . . . motor mechanism

90 . . . roller

95 . . . arrow

100 . . . bracket

110 . . . platen

120 . . . motor

125 . . . arrow

127 . . . arrow

129a/b . . . end mounts

130a/b . . . springs

135a/b . . . foundations

140 . . . computer

150 . . . first cable

160 . . . scanner

170 . . . second cable

180 . . . heater and blower combination

185 . . . third cable

190 . . . finisher unit

195 . . . fourth cable

200 . . . first ink jet edger assemblies

202 . . . second ink jet edger assemblies

205 . . . arrow

206 . . . bar

300 . . . ink ejection device

310 . . . second embodiment grain forming ink jet printer

312 . . . second embodiment print head

315 . . . second print swath

What is claimed is:

1. A grain forming ink jet printer for printing a grain on a workpiece, comprising:
(a) an ink jet print head;
(b) a spacer member associated with said print head;
(c) a support member spaced-apart from said print head; and
(d) a biasing mechanism coupled to said support member.

2. The printer of claim 1, further comprising a data storage unit coupled to said print head.

3. The printer of claim 2, further comprising a scanner coupled to said data storage unit.

4. The printer of claim 1, further comprising a dryer unit associated with said print head.

5. The printer of claim 1, further comprising a finisher unit associated with said print head.

6. The printer of claim 1, wherein said print head comprises a row of ink ejection orifices.

7. The printer of claim 1, wherein said print head comprises a plurality of rows of ink ejection orifices.

8. A grain forming ink jet printer for printing a grain on a workpiece, comprising:
(a) an ink jet print head adapted to apply ink onto the workpiece for printing the grain on the workpiece;
(b) a spacer member associated with said print head for maintaining a predetermined space between said print head and the workpiece;
(c) a support member spaced-apart from said print head for supporting the workpiece; and
(d) a biasing mechanism coupled to said support member for biasing said support member, so that said support member moves the workpiece into engagement with said spacer member.

9. The printer of claim 8, further comprising a data storage unit coupled to said print head for storing image data defining the grain and for transferring the image data to said print head.

10. The printer of claim 9, wherein said data storage unit is adapted to generate the image data.

11. The printer of claim 9, further comprising a scanner coupled to said data storage unit for scanning a sample grain, for generating the image data from the scanned sample grain and for transferring the image data to said data storage unit.

12. The printer of claim 8, further comprising a dryer unit associated with said print head for drying the ink applied to the workpiece.

13. The printer of claim 8, further comprising a finisher unit associated with said print head for applying a finish to the workpiece.

14. The printer of claim 8, wherein said print head comprises a row of collinearally-alligned ink ejection orifices, each orifice adapted to eject ink of a predetermined color.

15. The printer of claim 14, wherein said print head comprises a plurality of the rows of the ink ejection orifices.

16. A grain forming ink jet printer for printing a grain on a workpiece having an edge surface, comprising:
(a) an ink jet print head adapted to eject a plurality of ink drops onto the workpiece for printing the grain on the workpiece, said print head including a row of collinearly-aligned ink ejection orifices for printing a first print swath having a first width, each orifice adapted to eject a differently colored ink;
(b) a spacer member connected to said print head for maintaining a predetermined space between the orifices of said print head and the workpiece;
(c) a platen spaced-apart from and disposed opposite said print head for supporting the workpiece;
(d) a spring connected to said platen for biasing said platen, so that said platen translates the workpiece into engagement with said spacer member; and
(e) a computer electrically connected to said print head for storing image data defining the grain and thereafter electrically transferring the image data to said print head in order to operate said print head in response to the image data, so that the ink drops eject from the orifices in a predetermined sequence according to the image data transferred to said print head.

17. The printer of claim 16, wherein said computer generates the image data.

18. The printer of claim 16, further comprising a scanner electrically connected to said computer for scanning a sample grain, for generating the image data from the scanned sample grain and thereafter for transferring the image data to said computer.

19. The printer of claim 16, further comprising an electric resistive heater disposed proximate said print head for heating the ink drops on the workpiece in order to dry the ink drops on the workpiece.

20. The printer of claim 16, further comprising a finisher unit disposed proximate said print head for applying sealant onto said workpiece for sealing the ink drops to the workpiece.

21. The printer of claim 16, wherein said print head comprises a plurality of the rows of the ink ejection orifices, the orifices being collinearly-aligned from row to row for printing a second print swath having a second width wider than the first width.

22. The printer of claim 16, further comprising an ink jet edger assembly associated with said print head for forming the grain on the edge surface of the workpiece.

23. A method of assembling a grain forming ink jet printer for printing a grain on a workpiece, comprising the steps of:
(a) coupling an ink jet print head to a spacer member;
(b) disposing a support member to a position spaced-apart from the print head; and
(c) coupling a biasing mechanism to the support member.

24. The method of claim 23, further comprising the step of coupling a data storage unit to the print head.

25. The method of claim 24, further comprising the step of coupling a scanner to the data storage unit.

26. The method of claim 23, further comprising the step of coupling a dryer unit to the print head.

27. The method of claim 23, further comprising the step of coupling a finisher unit to the print head.

28. The method of claim 23, wherein the step of coupling an ink jet print head comprises the step of coupling an ink jet print head having a row of ink ejection orifices.

29. The method of claim 23, wherein the step of coupling an ink jet print head comprises the step of coupling an ink jet print head having a plurality of rows of ink ejection orifices.

30. A method of assembling a grain forming ink jet printer for printing a grain on a workpiece, comprising the steps of:
(a) coupling an ink jet print head to a spacer member, the ink jet print head being adapted to apply ink onto the workpiece for printing the grain on the workpiece and the spacer member being adapted to maintain a predetermined space between the print head and the workpiece;
(b) disposing a support member to a position spaced-apart from the print head for supporting the workpiece; and
(c) coupling a biasing mechanism to the support member for biasing the support member, so that the support member moves the workpiece into engagement with the spacer member.

31. The method of claim 30, further comprising the step of coupling a data storage unit to the print head for storing image data defining the grain and for transferring the image data to the print head.

32. The method of claim 31, wherein the step of coupling a data storage unit comprises the step of coupling a data storage unit adapted to generate the image data.

33. The method of claim 32, further comprising the step of coupling a scanner to the data storage unit for scanning a sample grain, for generating the image data from the scanned sample grain and for transferring the image data to the data storage unit.

34. The method of claim 30, further comprising the step of disposing a dryer unit proximate the print head for drying the ink applied to the workpiece.

35. The method of claim 30, further comprising the step of disposing a finisher unit proximate the print head for applying a finish to the workpiece.

36. The method of claim 30, wherein the step of coupling an ink jet print head comprises the step of coupling an ink jet print head having a row of collinearally-aligned ink ejection orifices, each orifice adapted to eject ink of a predetermined color.

37. The method of claim 36, wherein the step of coupling an ink jet print head comprises the step of coupling an ink jet print head having a plurality of the rows of the ink ejection orifices.

38. A method of assembling a grain forming ink jet printer for printing a grain on a workpiece having an edge surface, comprising:
(a) coupling an ink jet print head to a spacer member, the ink jet print head being adapted to eject a plurality of ink drops onto the workpiece for printing the grain on the workpiece, the print head including a row of collinearly-aligned ink ejection orifices for printing a first print swath having a first width, each orifice adapted to eject a differently colored ink, the spacer member being adapted to maintain a predetermined space between the orifices of the print head and the workpiece;
(b) disposing a platen to a position spaced-apart from and disposed opposite the print head for supporting the workpiece;
(c) connecting a spring to the platen for biasing the platen, so that the platen translates the workpiece into engagement with the spacer member; and
(d) electrically connecting a computer to the print head for storing image data defining the grain and thereafter electrically transferring the image data to the print head in order to activate the print head, so that the ink drops eject from the orifices in a predetermined sequence according to the image data transferred to the print head.

39. The method of claim 38, wherein the step of electrically connecting a computer comprises the step of electrically connecting a computer adapted to generate the image data.

40. The method of claim 38, further comprising the step of electrically connecting a scanner to the computer for scanning a sample grain, for generating the image data from the scanned sample grain and thereafter for transferring the image data to the computer.

41. The method of claim 38, further comprising the step of disposing an electric resistive heater proximate the print head for heating the ink drops on the workpiece in order to dry the ink drops on the workpiece.

42. The method of claim 38, further comprising the step of disposing a finisher unit proximate the print head for applying sealant onto the workpiece in order to seal the ink drops to the workpiece.

43. The method of claim 38, wherein the step of coupling a print head comprises the step of coupling a print head having a plurality of the rows of the ink ejection orifices, the orifices being collinearly-aligned from row to row for printing a second print swath having a second width wider than the first width of the first print swath.

44. The method of claim 38, further comprising the step of disposing an ink jet edger assembly proximate the print head for forming the grain on the edge surface of the workpiece.
